(19) United States
(12) Patent Application Publication
(10) Pub. No.: US 2011/0219105 A1
(43) Pub. Date: Sep. 8, 2011

(54) SYSTEM AND METHOD FOR APPLICATION SESSION CONTINUITY

(75) Inventors: David KRYZE, Campbell, CA (US); Junnosuke Kurihara, Milpitas, CA (US); Rohit Talati, Santa Clara, CA (US)

(73) Assignee: Panasonic Corporation, Osaka (JP)

(21) Appl. No.: 13/040,162

(22) Filed: Mar. 3, 2011

Related U.S. Application Data
(60) Provisional application No. 61/310,514, filed on Mar. 4, 2010.

(51) Int. Cl. G06F 15/16

(52) U.S. Cl. 709/223

(57) ABSTRACT

A first device pairs with a second device via local communication and then transfers a server-implemented application session from the first device to the second device by saving as session data the current state of the first application, and the state of the application-related data being consumed. This session data is then transferred to the second device, which then runs a second application based on the state supplied by the session data. One or both of the devices communicates a session transfer request to the server, causing the server to re-route application-related data to the second device to be consumed by the second application at the state where consumption by the first application was transferred.

### FIELD

The present disclosure relates to a system and method for providing a user with application session continuity between two or more devices.

### BACKGROUND

As mobile devices are increasing in popularity, so too are the applications therefore. For instance, mobile devices provide a user with applications for internet radio, social networking, video streaming, web browsing, and games. While some mobile devices may possess the processing capabilities to host these applications, the growing trend is to host these applications at an application server and serve the application over a network. This framework is sometimes referred to as cloud computing.

Currently, networking capabilities are becoming more feasible in the vehicle context as well. Either through dedicated mobile networking cards or via mobile devices, in-vehicle infotainment systems are also beginning to have networking capability. Accordingly, there will be a growing trend to provide applications specific to in-vehicle infotainment systems similar to those seen in mobile devices. Similar to the framework of application stores in the mobile device context, users will be able to purchase applications for their in-vehicle infotainment systems. Further, manufacturers of the infotainment systems will provide third parties with SDKs in order to provide the users with a vast array of purchasable applications. It is likely that the hosting of these applications will remain in a cloud as well. These applications can be controlled using the human machine interface (HMI) of the vehicle.

As the foregoing trend continues to materialize, there will be a growing demand for continuity between user devices and in-vehicle infotainment systems.

This section provides background information related to the present disclosure which is not necessarily prior art.

### DRAWINGS

The drawings described herein are for illustrative purposes only of selected embodiments and not all possible implementations, and are not intended to limit the scope of the present disclosure.

FIG. 1 is a drawing illustrating the relationship between two devices and an application server;

FIG. 2 is an exemplary method that may be performed to achieve application session continuity;

FIG. 3 is a block diagram illustrating exemplary components of a device configured to perform application session continuity;

FIGS. 4A and 4B are drawings illustrating data transfer in situations where a second device does and does not have connectivity to a communications network;

FIG. 5 is a drawing illustrating an example of a mobile device being used as input devices for a second device;

FIG. 6 is a drawing illustrating an exemplary user interface;

FIG. 7 is a drawing illustrating an exemplary user interface of an application after transferring to a vehicle infotainment system.

FIG. 8 is a hardware diagram illustrating communication between infotainment application, session continuity application and server;

FIG. 9 is a sequence diagram illustrating communication between devices and server to effect transfer of session;

FIG. 10 is a system diagram useful in understanding the session transfer operation;

FIG. 11 is a session transfer flow diagram useful in understanding the session transfer operation;

FIG. 12 is a further session transfer flow diagram;

FIG. 13 is a session continuity agent flow diagram;

FIG. 14 is a process diagram useful in understanding the driving context in a vehicle-based embodiment;

FIGS. 15-17 illustrate non-limiting example scenarios that may be accomplished using the systems and methods described herein.

Corresponding reference numerals indicate corresponding parts throughout the several views of the drawings.

### DETAILED DESCRIPTION

Example embodiments will now be described more fully with reference to the accompanying drawings.

A system and method of application session continuity is herein disclosed. Application session continuity provides a user with a seamless transition between the mobile device application environment and the in-vehicle infotainment system application environment. Used in this context, an application is a software program that is designed for a particular device. An application session is a particular instance of the application whereby each time the application is restarted a new session begins. Thus, application session continuity can be thought of as maintaining an application session over a plurality of devices. For example, a user may be streaming music to a mobile device through an internet radio application hosted at an application server as the user enters his or her vehicle. Using the disclosed framework, the user's session may be transferred to the infotainment system. The application server, or a corresponding application server, then streams the on-line radio content to the vehicle infotainment system. It is appreciated that this may be accomplished automatically or with little user interference. Application session continuity allows, for example, the application server to transfer service to the infotainment system at the same position of the same track that the user was listening to upon entering the vehicle. In other instances, Application session continuity may be achieved by starting a new application using the data from a previous application.

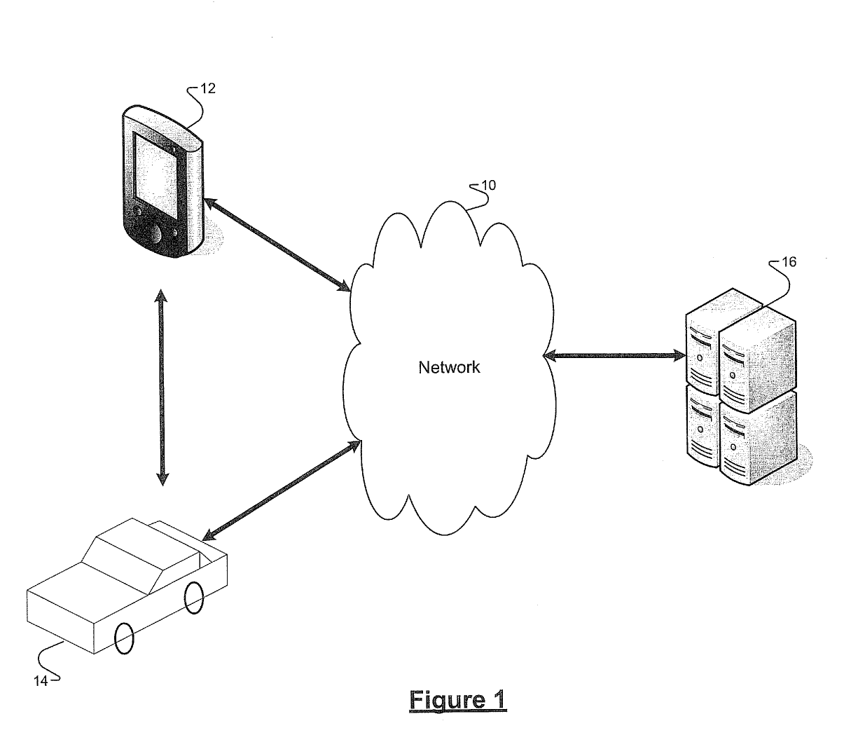

FIG. 1 is a drawing illustrating exemplary devices implementing application session continuity. In the figure two devices are shown, a mobile device 12 and a vehicle infotainment system 14 represented by a vehicle. It is appreciated that the two devices have communication capabilities with one another. For example, the mobile device 12 and the vehicle infotainment system 14 may communicate with one another via WPANs such as Bluetooth®, Zigbee®, via WiFi, or via a cabled connection such as a USB cord. Both devices 12 and 14 can communicate with an application server 16 over a communications network 10. It is appreciated that the devices are be configured to communicate with a plurality of application servers.

Using the foregoing framework, the application server 16 can serve a first application to mobile device 12 and a second application to the infotainment system 14. The operating systems of the mobile device 12 and the infotainment system 14 may be designed for significantly different platforms. Thus, an application designed to run on the mobile device 12 may not run on the infotainment system 14 and vice-versa. Accordingly, the application server 16 may serve modified versions of an application to the corresponding devices 12 and 14 to achieve substantially similar functionality.

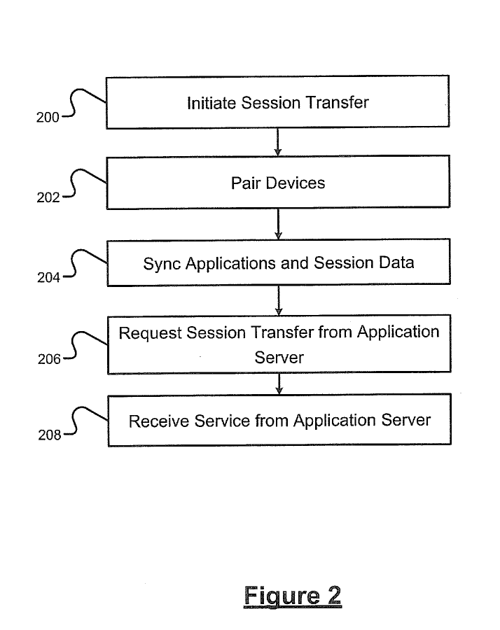

FIG. 2 illustrates an exemplary method for achieving application session continuity. First, a user will initiate a session transfer, as shown at step 202. This can be done automatically by bringing a recognized mobile device 12 into a communication range of the infotainment system 14, or by some user input. In the latter case, the user may perform a tangible gesture such as touching the mobile device to a predetermined location on the vehicle or by performing a predetermined gesture on a touch screen of the device or the HMI. An example of a tangible gesture is the user lightly bumping the mobile device 12 into a touch sensitive area associated with the infotainment system 14. Essentially, a signal within each device will indicate to the system that the user wishes to transfer a session.

Once the user has initiated the session transfer, the two devices will pair with one another, as shown at step 202. Pairing the devices can require the two devices to establish communication with one another. Once communication has been established with one another, the devices 12 and 14 can exchange information such as available applications. If a set of corresponding applications reside on the devices 12 and 14, e.g. both devices have an application for a particular internet radio service, then a list of transferable applications may be generated and displayed to the user at step 204. The user can select the desired applications to transfer the sessions, or this may be performed automatically. In the latter case, either device may have a predetermined list of applications that are automatically transferred or predetermined rules may govern which applications to automatically transfer, such as “if the user has a map application running on the mobile device, automatically open navigation application on HMI” or “if the user is streaming a radio application and the radio is ON in the vehicle then transfer the radio application session.” It is appreciated that the rules may be stored in a computer readable medium of either device. Further, as is discussed below, the absence of a particular application on the second device 14 may cause the device 14 to download the application or prompt the user to download the application. Once a particular session has been designated for transfer, one or both of the devices 12 and 14 may initiate a session transfer request to the application server 16, as shown at step 206.

The application server 16 will receive the request and any additional session data, i.e. data relating to the active session to be transferred, needed to effectuate the request, such as information associated with the application and specific to the session. For instance, a request for an application may be sent to the application server 16 and included in the request are parameters relating to the application session, such as a session identification number and a current state of the application session. Application specific examples of session data include, a particular calendar entry the user is viewing in a calendar application, a track number, track position and playlist in a music streaming application, or a selected movie and movie theatre in a movie finding application.

When the application server 16 receives the request, the application server 16 will then begin a new application session for the infotainment system 14 using the received session data to recreate the session running on the mobile device 12, as depicted at step 208. The session is recreated using the session data, whereby the newly created session begins at the point that the older session was transferred. For example, a video stream session may be initiated on the second device 14 and may begin at the same frame as the frame being shown on the first device 12 at the time of the session transfer. It is appreciated that if the same application can be run for both devices, then the session need not be recreated and service can merely be migrated to the destination device 14 by routing data to the IP address of the destination device instead of the mobile device 12. The application server 16 then serves the application to the infotainment system 14 as shown at 208. It is appreciated that the application server 16 may continue service to the mobile device 12, pause the service to the mobile device 12, or terminate the session of the mobile device 12 all together.

By performing the foregoing, one or more of the user's sessions are maintained, e.g. the same settings, same username, same media selections, without any or minimal interruption in the service over different context. An application context is the setting/platform in which the application is being used. For example, the different contexts may include a car setting, a mobile device, a personal computer, a laptop, an airplane, a motorcycle, a television, various consumer electronics, etc. It is envisioned that the foregoing framework may be applied between the listed contexts and are considered to be within the scope of this disclosure. For explanatory purposes, however, most explanations will be provided for maintaining session continuity between a mobile device and a infotainment system of a vehicle. It is understood that the disclosed can be applied to a wide array of contexts. For example, when a user steps onto an airplane and possesses a mobile device 12. The mobile device may transfer a video streaming application to the personal infotainment system in the user's seat. Similarly, when a user returns home and parks her car in the garage, a session may transfer the applications running on the vehicle infotainment system to the user's personal computer.

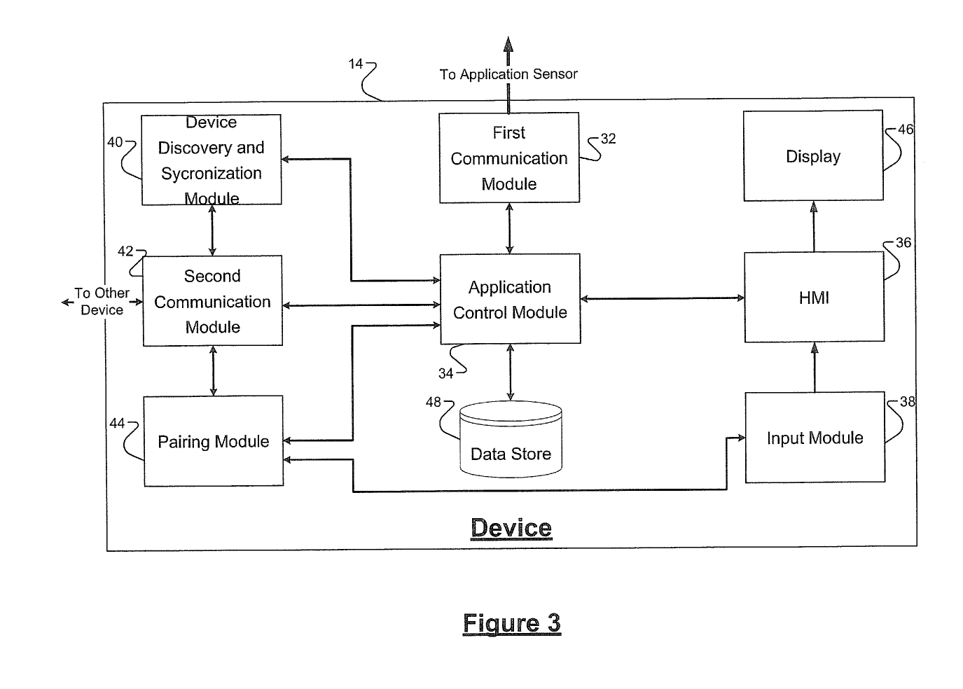

FIG. 3 illustrates the components of a device 14 configured to perform application session transfer. The components include a first communication module 32 that enables communication between the device 14 and the other device, e.g. the mobile device 12. The first communication module 32 can for example be a WiFi or WiMax transceiver. The first communication module 32 communicates application data from an application server 16 to an application control module 34. In some embodiments, the device 14 may not have WiFi or WiMax capabilities, that is, the device 14 may be unable to connect to the internet. In these instances, the first communication device 14 may tether to the mobile device 12 and use the mobile device 12 as a mobile router.

The application control module 34 controls various application sessions. For instance, the application control module 34 may determine which application the user has selected to run in the foreground and which applications to run in the background. Moreover, the application control module 34 receives data from an application server and communicates any changes required to the HMI 36 based on the received data. Conversely, any user input entered into the HMI 36 is received by the application control module 34 and communicated to the application server. Further, the application control module 34 communicates with a data store 40 to maintain the status of the various application sessions. For example, the application control module 34 may retrieve a user's username and password to communicate to the application server 16 via the first communication module 32. Additionally, the application control server 34 may store various parameters in the data store indicative of the state the application and/or the settings of the user when accessing a particular application. The application control module 34 is also configured to access an application marketplace. For example, in the vehicle context, the provider of the infotainment system may provide a SDK to developers so that a particular look and feel of applications can be achieved for the particular infotainment system. Via the first communication module 32, the application control module 34 can download the desired applications on the infotainment system. It is appreciated that although most of the processing is performed in a cloud, an application may still require that some software be installed on the device itself. The application control module is configured to additionally communicate with the HMI 36 of the device 14, a second communication device 42, and a paring module 44.

The second communication module 42 enables communication over a personal area network, e.g. Bluetooth® or Zigbee®, between the device 14 and other devices, e.g. the mobile device 14. It is envisioned in other embodiments other communications means, such as a WiFi connection can also be utilized. The second communication module 42 can be configured to sense other communication enabled devices within its vicinity, e.g. within 5 meters. To the extent the second communication device 42 senses such a device, it can begin communication with a communication module of the other device. It is appreciated that the other device may have to be registered with the device 14 or accepted as a communication partner to commence communication. It is envisioned that this functionality can be performed by a device discovery and synchronization module 40.

The device discovery and synchronization module 40 is configured to identify mobile devices present in the car and can propose a session transfer to the mobile device 12. Alternatively, the mobile device can propose the session transfer to the device discovery and synchronization module 40. Once the devices agree to a session transfer, device discovery and synchronization module 40 can receive a list of the active applications running on the other device. Before this can happen, however, the two devices will pair with one another. This can be performed by a pairing module 44.

The pairing module 44 is configured to pair the device 14 with other device 12 in a secure fashion. When performed automatically, the second communication module 42 receives signals from any device broadcasting signals within a vicinity. The broadcast signals will include an indicator indicating the identity of the device transmitting. The paring module 44 may receive this signal and compare the device identifier with a list of device identifiers stored in the memory of the device 14. If the device is identified, then the pairing module 44 establishes the communication between the two devices 12 and 14. While pairing can be performed automatically, the pairing module 44 can be configured to perform pairing upon a tangible gesture on the part of the user. In such configurations, the pairing module 44 determines that a pair is requested upon determining a sensor input of the user. For example, a request for pairing may be initiated by having the user tap the mobile device 12 on the screen of the display of the device 14. The mobile device 12 may recognize the tangible action request for transfer of services when an accelerometer associated with the device 12 senses a sudden acceleration and then a sudden deceleration of the device. The device 14 may recognize the tangible action request when the touch screen of the display is touched by the mobile device 12. When the predetermined gesture is recognized by both devices, the devices 12 and 14 treat the predetermined gesture as a request to pair. It is envisioned that the foregoing is an example of the pairing and that other means for pairing the devices exist. While it is envisioned that more passive means of pairing the devices exist, the tangible action may be useful for users because the tangible action represents a physical action indicating an explicit request to perform session transfer. Furthermore, tangible requests to pair can allow the device 14 to pair with a plurality of users.

Once the devices are paired, the device discovery and synchronization module 40 can perform application synchronization. The device discovery and synchronization module 40 on the device 14 can receive a list of active applications on the paired device. Device discovery and synchronization module 40 can then determine corresponding non-active applications on the device 14 by querying the application control module 34. Through user input or predetermined user settings or rules, the device discovery and synchronization module 40 determines which applications are to be synchronized.

If an application has not been downloaded to the device, the device discovery and synchronization module 40 can be configured to request from the application control module 34 that the application be downloaded.

Once an application session is set to be transferred, session data from the active application context is communicated to the non-active context in order to ensure session continuity. For example, in the example of the user entering the vehicle, the mobile device 12 of the user will transfer the session data for one or more of the active applications running on the mobile device 12 to the second communication module of the device 14. Session data may include an application id, a session id, a device id, and any data that may be relevant to the particular application and session, e.g. track number and position in a radio application. As mentioned, a list of active services or applications is determined and the current state of each application session is further determined. For example, if a user is listening to music streamed from an internet radio application, the current track, the position of the track and the playlist are transferred from the mobile device 12 to the device 14 via the second communication module 42. It is envisioned that in some embodiments, inactive session data may be sent as well, e.g. session data for inactive applications. This may be performed when the devices are configured to perform a full synchronization. It is envisioned that the synchronization can be performed via the second communication modules of the devices, e.g. over the PWAN, or over the network 10.

The device discovery and synchronization 40 can be further configured to communicate information to the paired device to aid in the session transfer. For instance, if the device 14 has an assigned IP address this information may be communicated to the paired device. It is appreciated that such information can be communicated to the application server 16 so that the application server 16 can serve a requested application to the device 14.

Once the session information has been synchronized, the application control module 34 can initiate the session transfer by requesting service from the application server 16. Alternatively, the paired device can send a request to the application server 16 to transfer the session to the device 14. Once the application server 16 receives the session transfer request the application server 16 can begin serving the application to the device 14. The application server 16 receives data from the application control module 34 of the device it is serving. Based on the application, the received data is treated as input and the application server 16 executes the application using the received data. Any change in state of the application is communicated by the application server 16 to the device 14 via the network 10. The application control module 34 updates the HMI based on the information received from the application server, i.e. the change in the state of the application.

It is appreciated that based on the user preference or the application itself, the application server 16 may stop service to the paired device, or may continue to serve the paired device.

Once the session has been transferred to the device 14, the application control module 34 can access the datastore 48 to retrieve the user settings. Furthermore, the application control module 34 may be configured to disallow particular applications from running in specific situations. For example, in the vehicle setting, a user may be prohibited by application control module 34 from continuing an email while driving. Accordingly, the decision to proscribe certain activities may be based on what is considered safe for a driver or on the governing laws in the country, region, state, or city. Once the user returns home, however, the user may be prompted to complete the email or another session transfer may transfer the email application session to the user's home computer.

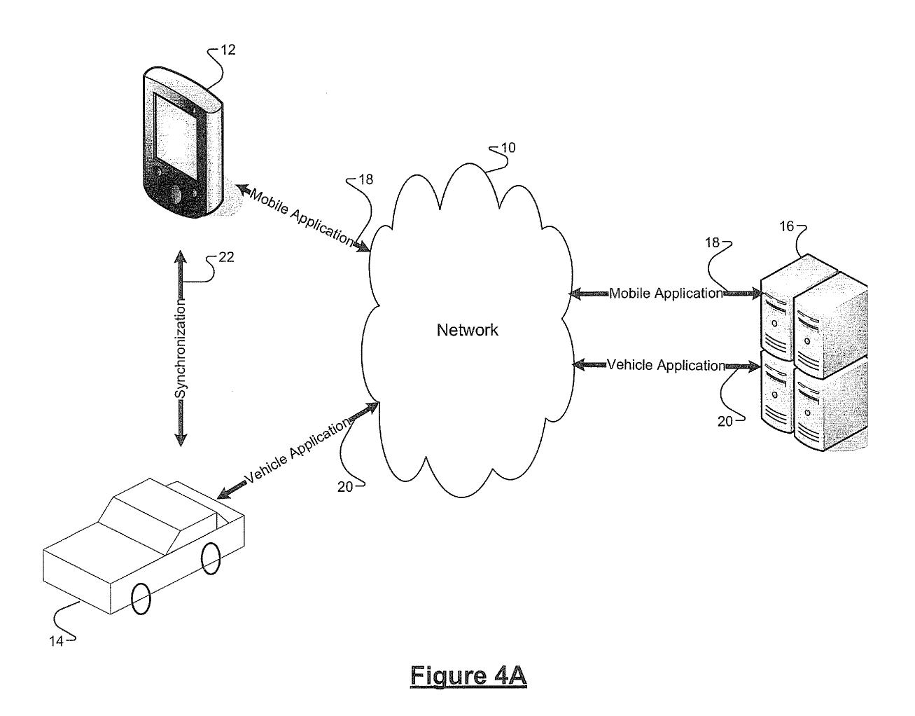

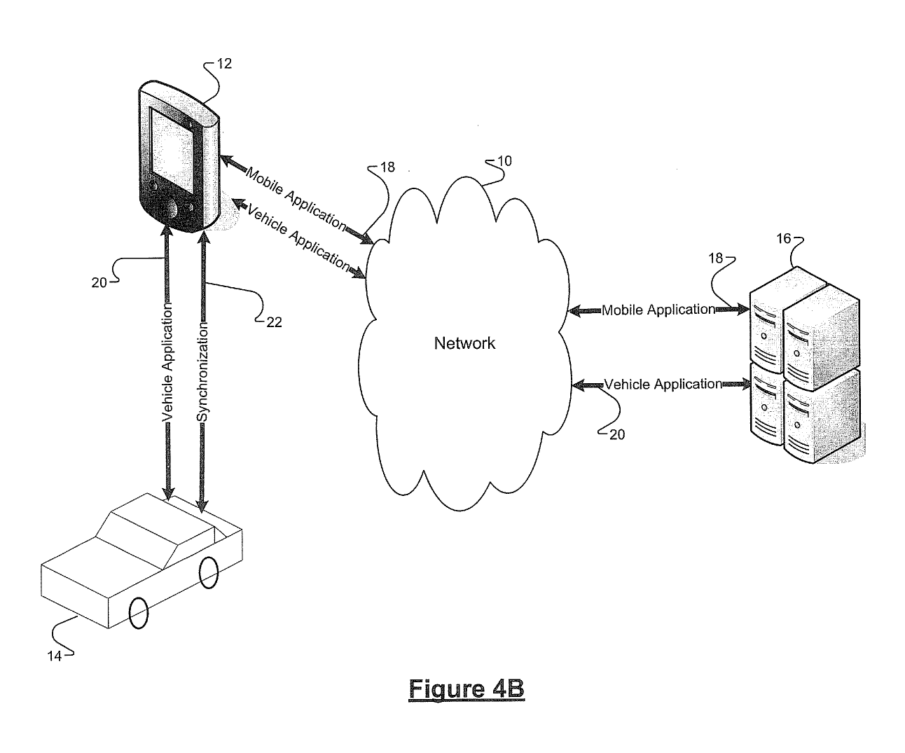

It is envisioned that the application session service to the second device, e.g. the vehicle infotainment system, may be effectuated in a number of ways. FIGS. 4A and 4B illustrate two alternative means to serve the application. In FIG. 4A, the application server 16 serves the mobile application 18 directly to the mobile device 12 over the network 10. The application server 16 also serves the vehicle application 20 to the vehicle infotainment system 14 over the network 10. In FIG. 4B, the vehicle infotainment system 14 is assumed to not have a direct connection to the network 10. In this instance, the vehicle infotainment system 14 can tether to the mobile device 12 as described above. The application server will then serve the vehicle application 20 to the vehicle infotainment system 14 using the mobile device 12 as an intermediate relay.

Additionally, while the application transfers discussed above have assumed the application server 16 serving a substantially similar application, the device may be configured to select a transfer of a related application. For instance, if a user is running a first application on the mobile device 12, e.g. a restaurant from a restaurant recommendation application or has selected an appointment from a calendar, the device 14 may request to initiate a navigation application session using the session data from the mobile device during synchronization. If the user has selected a restaurant on the mobile device 12, the infotainment system 14 may initiate a navigation application using the restaurant selection's address, which is received as session data. It is envisioned that the application control module 30 can be configured to perform such intelligent inferences based on an analysis of the session data received during synchronization.

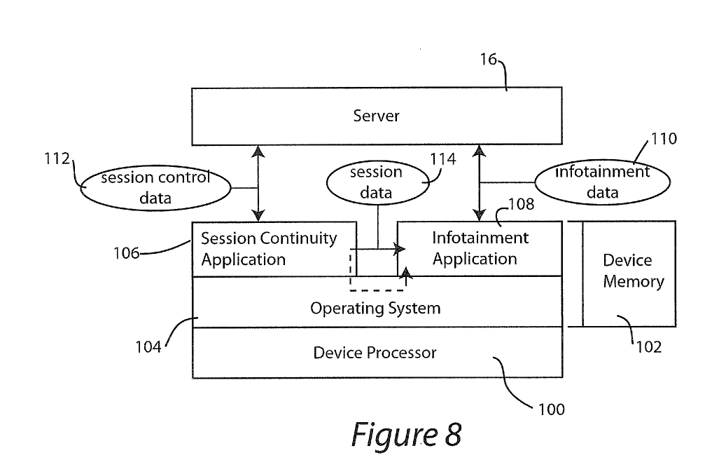

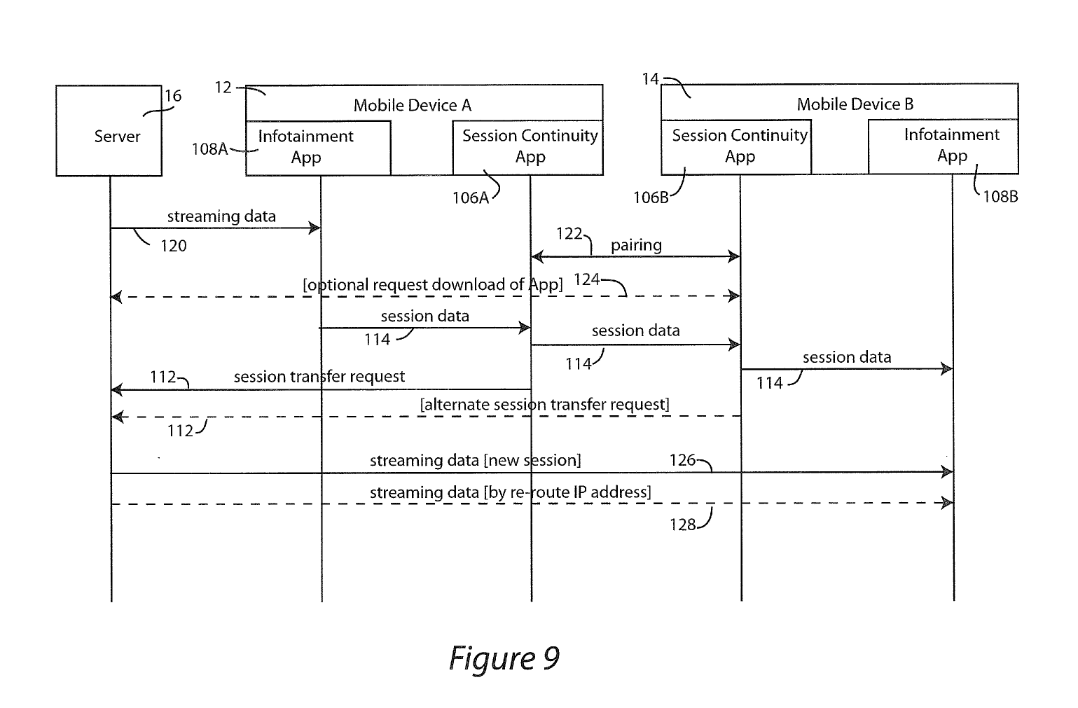

While various different embodiments are possible, FIGS. 8 and 9 provide an exemplary embodiment in which session continuity is performed by a session continuity application that runs on the device along with one or more infotainment applications. As will be explained, the session continuity application mediates session control and transfer among devices, leaving the infotainment applications free to handle the infotainment tasks they are natively designed to handle.

Referring to FIG. 8, the mobile device (both mobile device 12 and infotainment system 14 are considered to be mobile devices in this context) includes a device CPU or processor 100 to which a memory device 102 is coupled. The memory device 102 is configured to store processor-readable instructions and also data that the processor operates upon as it performs the stored instructions. The memory device 102 thus provides non-transitory storage of machine-readable instructions and data.

More specifically, the memory device 102 is configured to store a set of operating system instructions 104 that provide basic communication and memory access operations implemented by the processor 100, including providing support for one or more application programs that may be selectively executed by processor 100. In this regard, memory 102 has stored therein a session continuity application as well as one or more infotainment applications, such as the illustrated infotainment application 108. The device is adapted to communicate with server 16 to obtain infotainment data 110 as well as to exchange certain session control data 112. The infotainment data may include, for example, streaming data or other content to be consumed. If needed, the infotainment data may also include executable application program instructions for loading and running on the device, such as an executable copy of an infotainment application 108.

The session continuity application 106 communicates with the server 16, as will be more fully explained in connection with FIG. 9, to mediate the transfer of an application session from one device to another. As part of this transfer process, the session continuity application assists by causing session data 114, obtained from another device to be loaded for use by the infotainment application 108. Thus as illustrated, session data 114 is shown being passed from session continuity application 106 to infotainment application 108. As illustrated by the dashed lines, this transfer of session data may be handled with the assistance of the operating system 104.

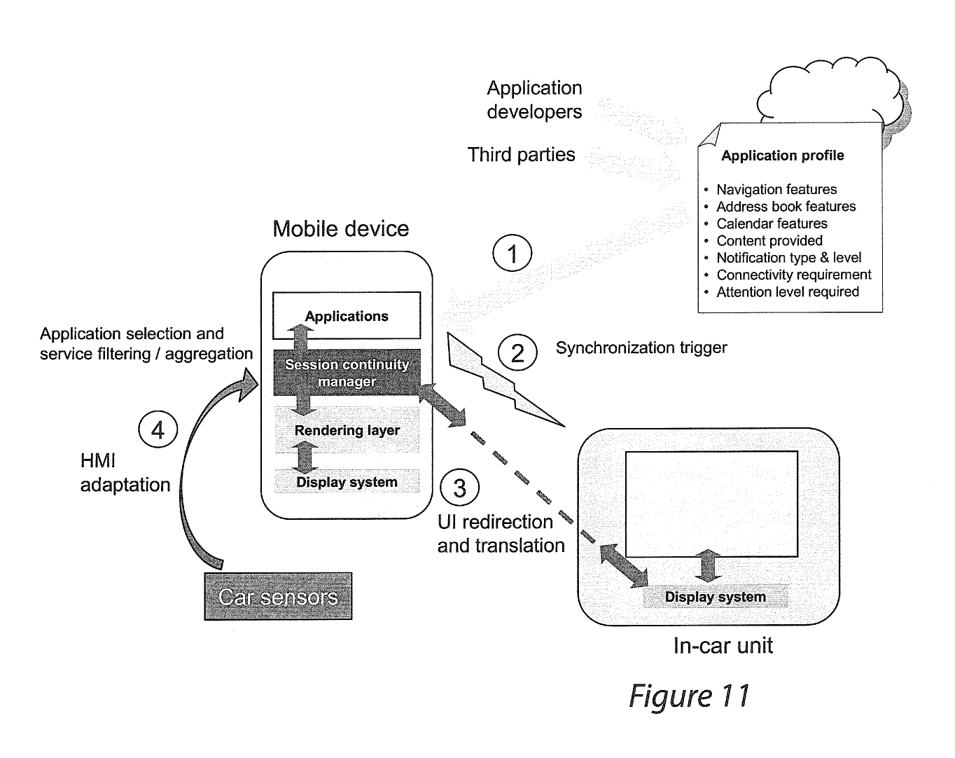

While the session continuity application 106 has been illustrated in FIG. 8 as a standalone application, loaded and managed in a fashion similar to the infotainment application 108, it will be understood that the continuity application 106 may be implemented at a different layer, such as at a layer administered by the operating system. This has been illustrated in FIG. 11, where the session continuity application is shown as a session continuity “manager” that interfaces between the rendering layer of the operating system and the installed applications, such as an infotainment application.

Referring now to FIG. 9, the interaction among server and mobile devices 12 and 14 to effect application session transfer involves interaction between and among session continuity applications 106A, 106B of the respective mobile devices 12 and 14. Again, in this context both mobile device 12 and infotainment system 14 are considered to be mobile devices. Device 12 may be for example a handheld mobile device and device 14 may be an infotainment system installed in the dashboard of a mobile vehicle.

FIG. 9 shows how infotainment data (in this case streaming data) and session control data (messages) are passed between and among the various components of the server and mobile devices. Beginning at 120, server 16 is seen as sending streaming data to the infotainment application 108A of mobile device 12. Of course the data being sent could be in a form other than streaming data, thus the depiction of streaming data here is for explanation purposes only.

Now, assume that the user of mobile device 12 comes into proximity of mobile device 14 while enjoying the streaming data via infotainment application 108A. For example the user of handheld mobile device 12 gets into his or her car and turns on the ignition, which turns on mobile device 14 and initiates a pairing sequence 122 between devices 12 and 14. Pairing 122 may be initiated automatically, or by user instruction, depending on user preferences and/or other constraints of the respective devices.

As part of the pairing sequence 122, the session continuity application 106B communicates with its counterpart session continuity application 106A to determine what infotainment application will be needed on device 14 in order to receive transfer of the session. If the required infotainment application is already stored within the device memory 102 of device 14, then session continuity application 106B sends a message through its associated operating system 104 to launch that infotainment application if it is not already running. If the required infotainment application is not stored within the device memory of device 14, the session continuity application 106B sends a download request to server 16, as at 124, whereupon the sever 16 responds by transmitting the requested application program to device 14 and the operating system of device 14 will install and launch the requested application program.

Now that both devices 12 and 14 have a suitable infotainment application running, the session continuity applications 106A and 106B cooperate to transfer session data from infotainment application 108A to infotainment application 108B. As illustrated, this transfer may be passed through the respective session continuity applications as session data 114 (see also session data 114 in FIG. 8).

Next, the session continuity application 106A (or optionally or additionally session continuity application 106B) sends a session transfer request message to the server as session control data 112 (see also session control data 112 in FIG. 8). The session control data 112 may include any applicable metadata or session control data needed by the server to know, what specific portion of the data the user is currently enjoying. For example, if the streaming data is recorded must, the session control data would include metadata such as the song ID, track number, track position counter and other playlist information. The server responds to this request by either starting a new streaming data session 126, or by re-routing the existing streaming data session to the IP address of device 14, as at 128.

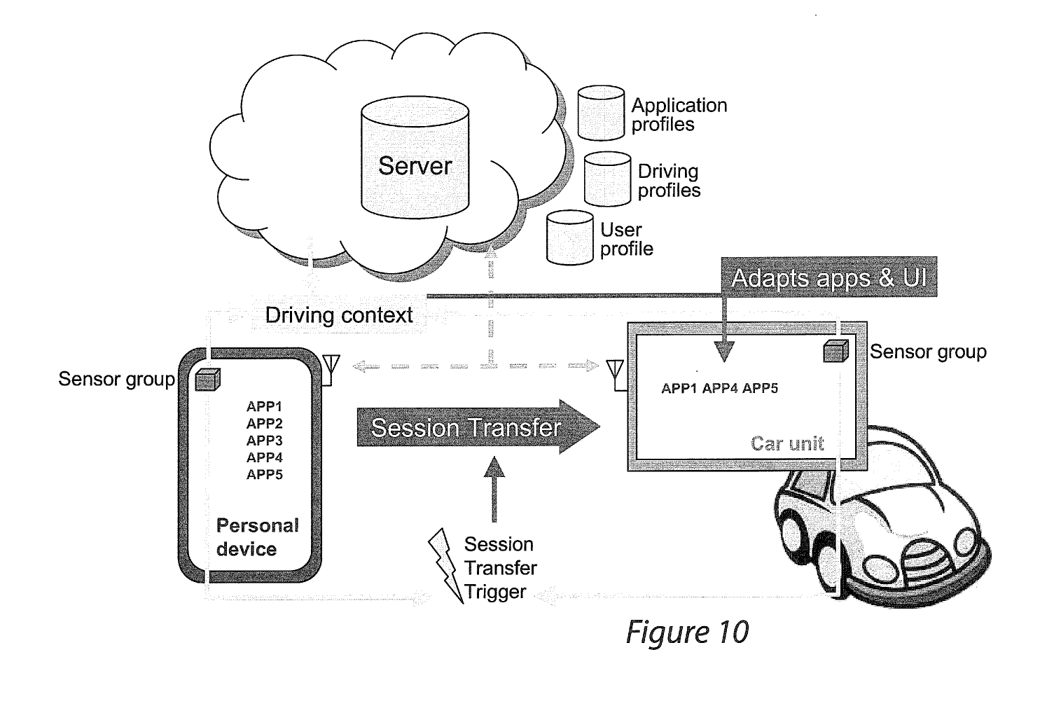

Referring to FIG. 10, the system comprising the server and the mobile devices can include a set of profiles that govern how the system allows devices to consume the application-related data (such as streaming data) based on user profiles, application profiles and driving profiles. For example a session begun on a personal device, such as a mobile phone might be expressed differently when transferred to an infotainment system within a vehicle. Certain features may be changed or suppressed to account for the fact that the user is now operating a vehicle and may have different requirements than when using his or her mobile phone.

As illustrated in FIG. 11, when the application session is transferred, an application profile that defines certain attributes necessary for proper operation of the infotainment application can be downloaded to the mobile device(s). The session continuity application, functioning as a session continuity manager in this case, provides the synchronization trigger to cause the in-car unit to pair with the mobile device and commence the session transfer. This may entail sending instructions to the in-car unit and/or mobile device to alter the user interface to an appropriate mode to suit the infotainment application being controlled.

The session continuity application or session continuity manager may perform application selection and service filtering or aggregation to assist in adapting the user interface (human user interface HMI) as appropriate. Aggregation involves defining different dimensions by which the infotainment application functions may be characterized. The session continuity application or session continuity manager groups functions performed by the infotainment application into aggregated groups, so that other applications can be integrated with the infotainment application. For example, a basic ability to look up telephone numbers might be aggregated with the ability to look up addresses, and the resulting aggregate might be used to help an in-car navigation system find desired travel locations based on the user's interaction with the infotainment application.

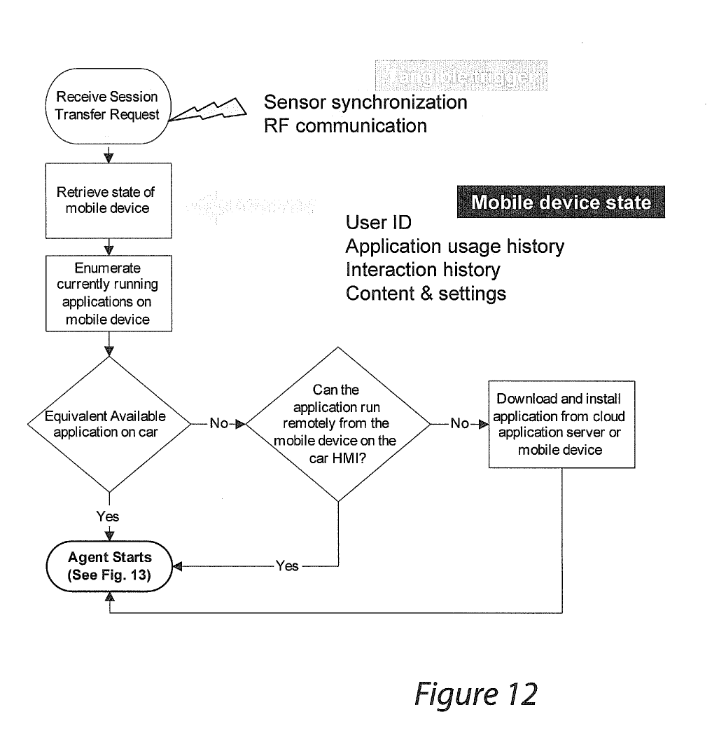

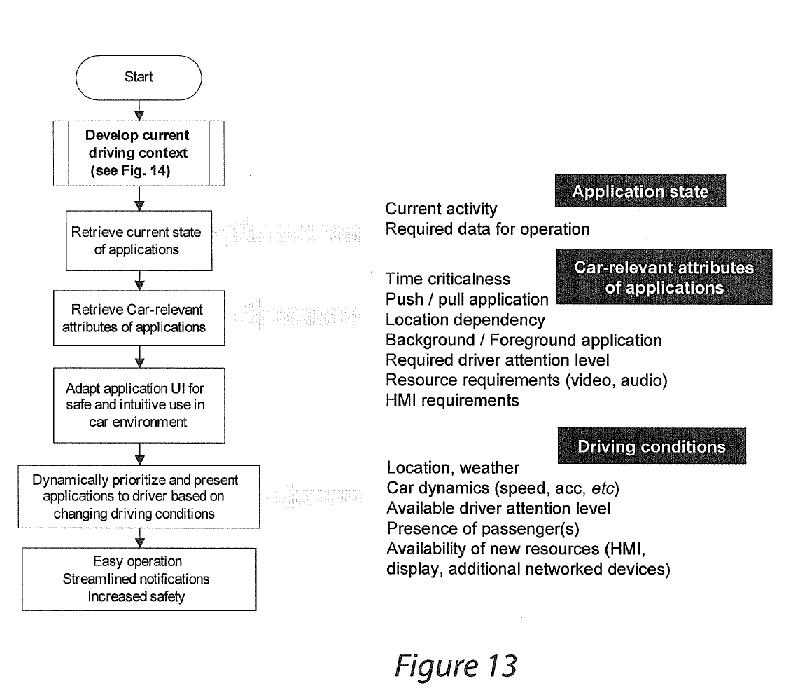

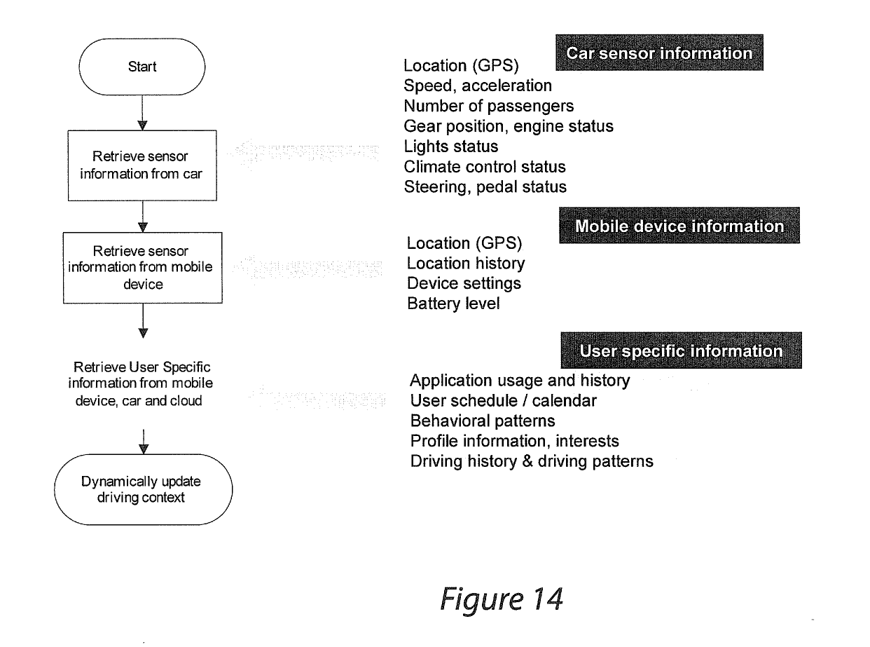

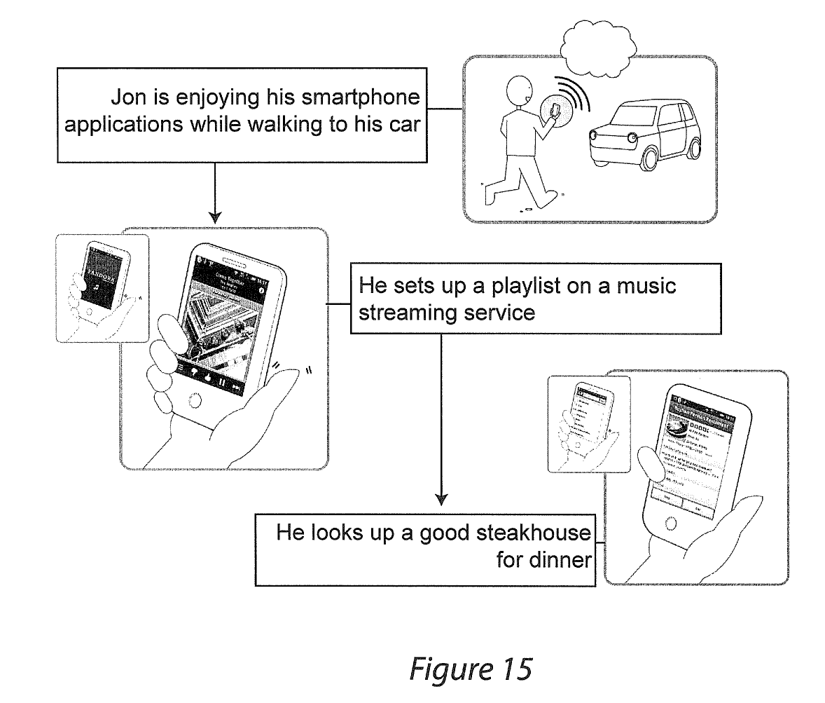

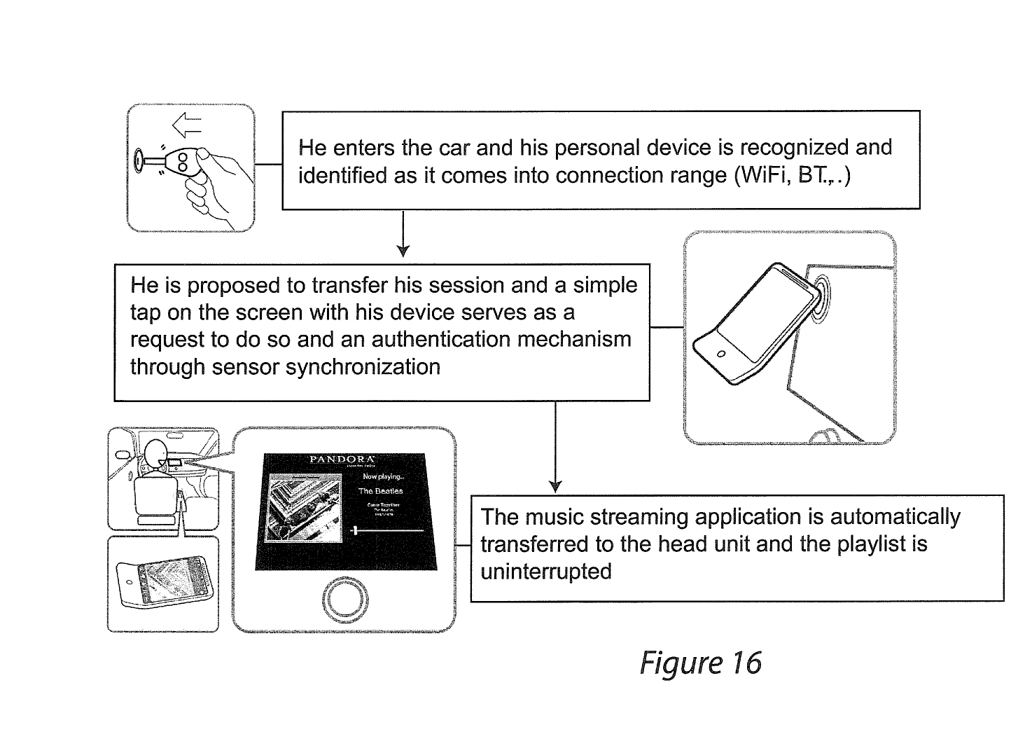

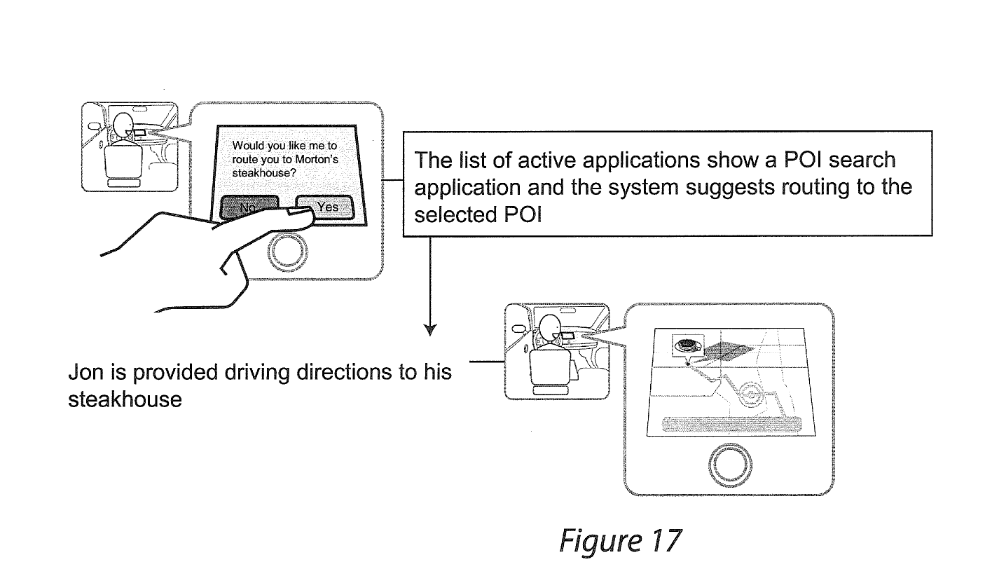

FIG. 12 shows in further detail how the session transfer flow may be performed. FIG. 12 more specifically shows how the system determines how and when to load or download an equivalent application if the infotainment application from the first mobile device is not present. FIGS. 13 and 14 then continue, showing how application state and other context information is utilized. Some example use cases are then shown in FIGS. 15-17.

While session transfer has been explained with respect to one transferring device, it is appreciated that the foregoing may be applied to multiple transferring devices. For instance, if two users enter a vehicle, each user may synchronize their respective sessions with the vehicle infotainment system. The HMI, as is described below, can be configured to accommodate multiple session transfers from multiple devices, as the HMI allows a user to browse through multiple applications.

In another aspect of the disclosure, the user interface for each application context (car, home, mobile, etc.) can have its own user interface. Each context has different user interface settings that make the most sense for the user. In the television setting, for instance, the user may be more accustomed to control an application via a remote control. In the airplane context, a user may be more accustomed to controlling an application via touch screen.

It is appreciated that vehicle applications are not the same as their mobile counterparts, as the vehicle interface is characterized by different input and output mechanisms. Thus, vehicle applications need to be “vehicle compatible” in order to offer the session continuation feature, which can be made part of the default framework. Applications that are not made “vehicle compatible” however, could still be accessed in their mobile-counterpart's look and feel.

Considerations about the UI for each application context depend not only on what the user may most enjoy or what the user is accustomed to, but can also be based on what is safe for the new context's environment and/or what may be allowed by law. Thus, applications designed for specific contexts can be customized by country, region, setting, and other considerations.

In the vehicle context, the user interface is configured to make the user's interaction with the HMI easier and less distracting when the vehicle is in motion. For instance, in some embodiments the UI is color coded for when the vehicle is in motion as opposed to when not in motion. Further, the UI can have additional color codes depending on the application being used or the state of the system, e.g. the home screen is blue and downloaded applications are in other colors. The UI can adjust the contrast based on the output of a light sensor in the car or the screen colors may be inverted based on the output of the light sensor. Further, the UI can incorporate voice input commands and audio feedback when the vehicle is in motion. The forgoing list of implementations for the UI are exemplary and are not intended to be limiting.

Referring back to FIG. 2, it is appreciated that the device also includes a display 46, an HMI 36, and an input module 38. It is envisioned that these three components work together to effectuate an interaction between the user and the device 14. In the vehicle context, the display 46 is the display unit of the infotainment system 14. The screen may be any screen known in the art, including a touch sensitive screen. In these embodiments, the display 46 may also act as an input module 38. The input module 38 may also be a microphone and speech analyzer such that voice input is enabled. The input module 38 receives user input, e.g. touch input, voice input, or typed input, and converts the user input into a signal that is communicated to the HMI 36. Based on the received signals the HMI translates the received input into a command for the application control module 34.

In the vehicle context the HMI can be further configured to receive input from multiple sources. It is envisioned that in some embodiments, the HMI may be further configured to receive input from a paired user device such as a mobile device, in addition to receiving input in the manners described above. In these embodiments, the user may select to use the mobile device as an input means. Via the PWAN, for example, the mobile device 12 can communicate input signals to the vehicle infotainment system 14. The input module 38 deciphers the received command and communicates it to the HMI 36.

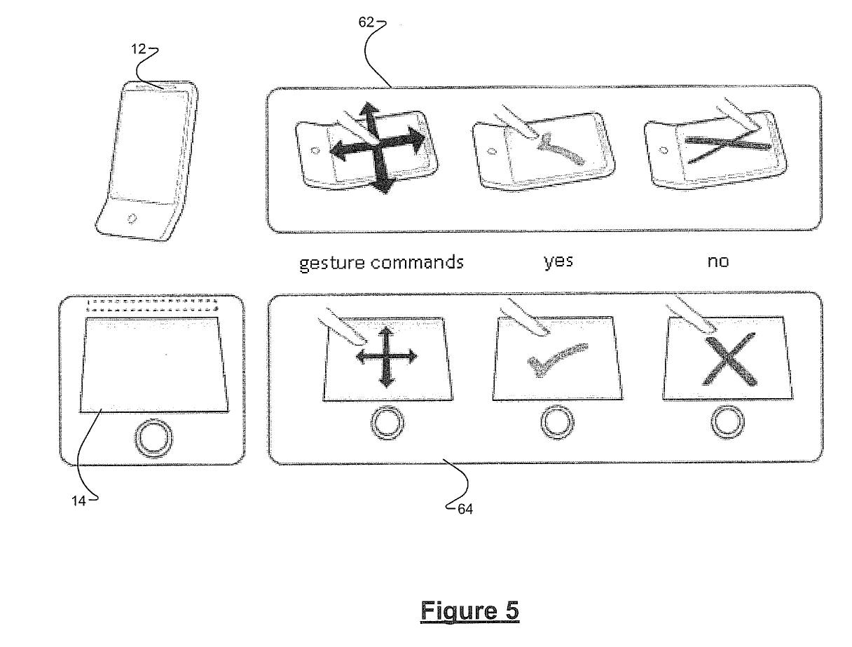

It is envisioned that in such embodiments, the touch screen of the mobile device can correspond to the touch screen of the infotainment system. FIG. 5 illustrates this concept. Shown in the figure are the mobile device 12 and the infotainment system 14. Reference numerals 62 and 64 illustrate how specific gestures on the mobile device would be performed on the infotainment system's display screen. As can be seen, using the foregoing, the user can use the mobile device 12 as a wireless input device. This option can allow the user more comfort and less distraction when interacting with the HMI. To further aid the user, the input means of the mobile device 12 or the HMI of the infotainment system 14 can be configured to recognize when a user is drawing a letter on the touchpad. By drawing the letter, the HMI can retrieve a list of applications starting with the inputted letter. For example, if a user were to draw the letters “ph,” the HMI may retrieve the “phone” related applications.

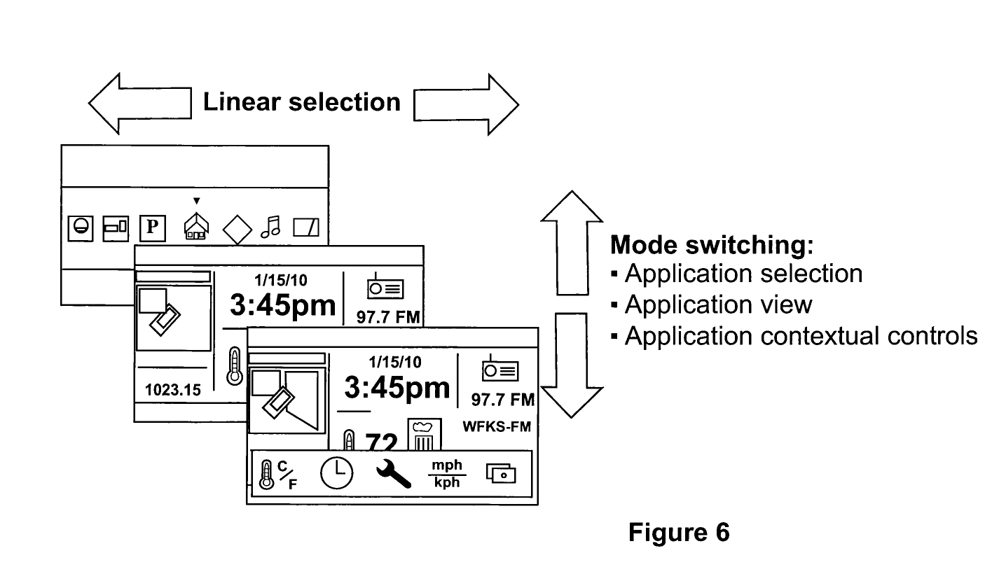

As can be appreciated, with the majority of applications being hosted in a cloud and served to the infotainment system 14 over a network 10, the user may have multiple applications running concurrently. To facilitate multiple applications that may have been transferred from one or more devices or initiated from the infotainment system itself, the HMI can be configured for easy navigation through applications and within the application menus. FIG. 6 illustrates an exemplary user interface configured as a linear carrousel. As can be seen, the user can navigate laterally to change applications and can navigate within the application menus horizontally. The foregoing is provided for exemplary purposes and it is appreciated that many different configurations of the user interface are contemplated.

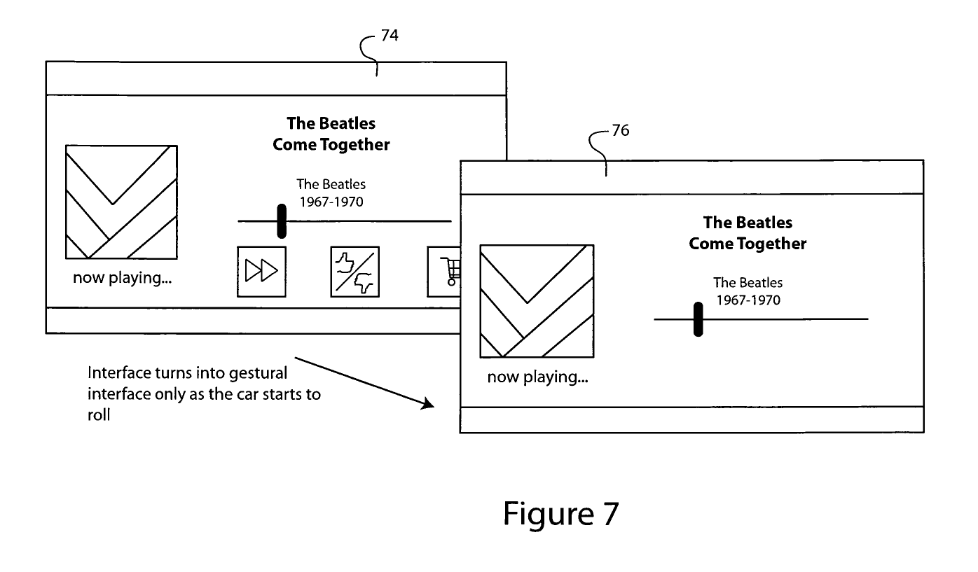

As discussed above, the HMI 36 can be further configured to decrease the amount of distractions to a driver in the vehicle context. For example, interaction with the driver's infotainment system's 14 UI can be disabled while the car is in motion in order to enforce compliance with laws and regulations. This offers the opportunity to use the mobile device 12 as a controller for the car system. Available interactions with the UI can be restricted based on the driving mode. For example, as shown in FIG. 7, clickable buttons 72 are removed from the UI when the vehicle is in motion. On the right screen 76 the actual buttons disappear in the car-context application when the car is moving. In this embodiment, only gestural input is permitted so the user does not have to look at the screen and try to press a small or specific icon. It is envisioned that other safety features may also be built into the vehicle's infotainment system to avoid driver distraction.

With respect to the architecture described above, a general server-client model was described, such that an application server serves the application to the device. It is envisioned, however, that other architectures may be implemented. For example, the application may be hosted on the mobile device 12. Upon a session transfer the mobile device 12 would serve the application to the infotainment system 12. In these architectures, the mobile device 12 could store the information needed for a session transfer, including a configuration of the HMI of the infotainment system, data for performing context analysis, and a methodology for service adaptation.

In other architectures, the infotainment system HMI could be run from the mobile device 12. In these instances, the application could be considered monolithic, in that only one copy of the application need exist, and the HMI of the infotainment system could operate as a browser. Using this configuration, the user interface of an application is pushed from the mobile device, or application server, to the infotainment system.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. Furthermore, it is appreciated that the components described herein may be embodied as computer readable instructions executable on a processor associated with a corresponding device.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for transferring an application session from a first device to a second device comprising:
on the first device, running a first application that consumes application-related data from a server;
obtaining session data from the first application, the session data capturing a current state of the first application and further indicative of a state of the application-related data being consumed by the first application;
transferring said session data to the second device;
using at least one of said first and second devices to communicate a session transfer request to the server which causes the server to direct said application-related data to the second device;
on the second device, running a second application that uses the session data to consume the application-related data from said server according to the state of the application-related data captured by the session data from the first application.

2. The method of claim 1 wherein said step of transferring said session data to the second device is performed by local communication between the first and second devices.

3. The method of claim 1 wherein said first and second applications are separate instantiations of the same application.

4. The method of claim 1 wherein said step of communicating a session transfer request conveys at least a portion of the session data to the server.

5. The method of claim 1 wherein said step of communicating a session transfer request includes re-directing the application-related data from the IP address of the first device to the IP address of the second device.

6. The method of claim 1 wherein the first and second devices are selected from the group consisting of mobile devices and vehicle-mounted devices.

7. The method of claim 1 wherein at least one of said first and second devices includes a gestural interface and wherein the step of transferring session data to the second device is controlled by a user-supplied gesture via said gestural interface.

8. The method of claim 1 further comprising the step of pairing said first and second devices via local communication prior to transferring said session data to the second device.

9. The method of claim 1 further comprising running a session continuity application on the first device concurrently with the first application, the continuity application performing the step of obtaining session data from the first application and transferring said session data to the second device.

10. The method of claim 1 further comprising running a session continuity application on the each of said first and second devices, the continuity applications cooperating with one another in performing the step of obtaining session data from the first application and transferring said session data to the second device.

11. The method of claim 9 further comprising delivering an application profile to said session continuity application, the application profile providing configuration information about the first application used in obtaining session data from the first application.

12. The method of claim 10 further comprising delivering an application profile to said session continuity application, the application profile providing configuration information about the second application used by the session continuity application in interpreting session data from the first application.
